(19) United States
(12) Patent Application Publication
(10) Pub. No.: US 2010/0142310 A1
(43) Pub. Date: Jun. 10, 2010

(54) Extrusion Conveying Device

(75) Inventors: Reinhard Uphus, Hannover (DE); Florian Fischer, Ebersberg (DE)

Correspondence Address: ROBERT W. BECKER & ASSOCIATES, 707 HIGHWAY 333, SUITE B, TIJERAS, NM, 87059-7507, US

(73) Assignee: VMI-AZ Extrusion GmbH, Runding (DE)

(21) Appl. No.: 12/580,188

(22) Filed: Oct. 15, 2009

(30) Foreign Application Priority Data
Oct. 16, 2008 (DE) 10 2008 051 973.1

(51) Int. Cl. B29B 7/28

(52) U.S. Cl. 366/76.2; 366/132

(57) ABSTRACT

An extrusion conveying device having an extruder for the mixing of components, in particular a rubber mixture or TPE. A volumetrically operating conveyor, especially a gear pump, is disposed at the output side of the extruder. A subsidiary conveyor supplies to the extruder at least one component having a marker substance. A detection device for the marker substance is disposed on the output side of the extruder and/or the volumetrically operating conveyor for detecting the distribution quality of the marker substance. A control device is coupled to the detection device for adjusting the speed of the extruder and/or the volumetrically operating conveyor in response to the detected distribution quality of the marker substance detected by the detection device.

### BACKGROUND OF THE INVENTION

The instant application should be granted the priority date of Oct. 16, 2008, the filing date of the corresponding German patent application 10 2008 051 973.1.

The invention relates to an extrusion conveying device.

Extrusion conveying devices have become known from various embodiments. From EP 599 104 A2 it has become known to supply two components reacting with one another. A control means is provided for adjusting the pressure depending on the viscosity of the mixture.

This examination requires a specific viscometer to which the mixture has to be applied. Viscometers of this kind are known per se, however, require specific precautionary measures when changing the mixture in order to prevent remains of the mixture used before contaminating the new mixture. Only the medium mixing quality that exists within the entire volume of the viscometer, can be determined. The dispersion and local differences of the distribution in the volume cannot be detected.

The control of the viscosity of plastic materials is for example also already known from DE 36 42 757 A1, wherein said arrangement uses quick-spinning equipment and is intended to incorporate the temperature into the control loop.

In this approach, the pressure difference of a measured section is quickly detected in order to determine the viscosity. In this respect, this arrangement also represents a rough viscometer.

Further, it has already been proposed to determine the product quality of plastic materials by using different other sensors. One example is the usage of ultrasonic sensors that are to perform an undisturbed quality inspection during the manufacturing process. This kind of inspection indeed permits a control of the product quality of specific plastic materials. However, it is less suited for controlling the mixing quality of various mixtures and in this respect for having an impact on the product quality.

Moreover, according to the German patent application DE 10 2007 045 533.1 it has been proposed to develop an extrusion conveying device that uses multiple volumetric subsidiary conveyors and with the aid of which the speed of rotation of the extruder can be adjusted independent of the feed rate and the volume flow of the volumetrically operating output-sided conveyor. Thus, the supply of various components of a rubber mixture is successfully optimized also in connection with optionally provided pressure sensors and the product quality is maintained in this manner.

On the other hand, it would be desirable to still more precisely detect and better control the mixing quality of the components supplied.

For this reason, the invention is based on the object of providing an extrusion conveying device of the aforementioned general type that with regard to the controllability and the product quality achieved in this way is still further improved and in particular is suitable for the production of rubber mixtures.

### SUMMARY OF THE INVENTION

This object is inventively solved by an extrusion conveying device comprising: an extruder for mixing components, in particular a rubber mixture or thermoplastic elastomer (TPE); a volumetrically operating conveyor, especially a gear pump, disposed at the output side of the extruder; at least one subsidiary conveyor for supplying to the extruder at least one component having a marker substance; a detection device for the marker substance disposed on the output side of the extruder and/or of the volumetrically operating conveyor, with the detection device being adapted to detect the distribution quality of the marker substance; and a control device coupled to the detection device and adapted to adjust the speed of the extruder and/or of the volumetrically operating conveyor in response to the distribution quality of the marker substance detected by the detection device.

According to the invention it is particularly favorable that the provision of a marker substance in one component of the inventive extrusion conveying device comprising the inventive detection device, allows for the accurate detection of the distribution of the component in the mixture.

Here, it can particularly be taken advantage of the fact that with the aid of the extruder, for example having a transfer mix region or a pin extruder region for improving a thorough mixing, a very uniform or constant blending having a local deviation of less than 5%, in particular less than 3%, can be achieved. In this way it is possible to determine the proportion of the component in the mixture by simply comparing the proportion of the marker substance in the component with the proportion of the marker substance in the mixture.

The detection device can detect the distribution of the marker to substance if it is implemented in the form of particles, wherein it is particularly favorable if an optical or electromagnetic detection in the broadest sense is realized and if the marker substance is correspondingly emitting.

It is possible, for example, to introduce fluorescent or luminescent particles into the component. The mixture is then inspected via a window provided, and the sensor of the detection means is directed towards the surface of the mixture.

It is preferred that the the emission spectrum of the marker substance coincides with the sensitivity maximum of the sensor.

However, for example, it is also possible to use reflective marker substances and to apply an electromagnetic radiation such as light to the mixture via the window, and to measure the reflection rate, in order to ascertain the distribution of the component in the mixture.

Moreover, there is the possibility of realizing the marker substance in the form of radioactive or magnetic particles; this possibility, however, basically being only feasible or practicable if the respective particles in the finished product do not interfere, at least not in the concentration provided.

According to the invention it is particularly favorable if the detected mixing result is used for controlling the inventive conveying device. To this end, for example, it is possible to contol the speed of rotation of the extruder and/or the speed of rotation of the output-sided conveyor, or the speed of rotation of the subsidiary conveyor. In case the distribution quality is too high, it is possible to reduce the speed of rotation of the extruder such that it consumes less power and is capable of operating at lower temperatures. If the distribution quality is dissatisfactory, the speed of rotation of the extruder can be increased in order to achieve better blending or intermixing, or in the individual case it is possible to reduce the speed of rotation of the remaining conveyors in order to achieve the same result.

Further, it is also possible to add the marker substance of the component to the mixture that is fed to the extruder, wherein this embodiment is particularly expedient if a relatively high portion of the mixture is supplied via at least one subsidiary conveyor.

In one embodiment of the invention it is provided to use particles anyway required at least partially for providing the marker substance, said particles being for example soot particles that are used for producing the abrasion resistance of a tread or that are used in tire manufacturing, or for example color particles that serve for the coloring of the mixture and that can be supplied in the form of a dispersion or powder.

According to the invention, however, it is preferred to provide a part of the crosslinking system or the entire crosslinking system with the marker substance that is supplied via a subsidiary conveyor that preferably comprises a subsidiary extruder and a subsidiary gear pump and thus enables accurate metering of the marker substance.

A further advantageous embodiment of the invention provides for the evaluation of the coloring of the mixture caused by the marker substance supplied and to use the evaluation result for controlling the mixing ratio.

In a further advantageous embodiment of the invention it is provided that the sensor of the detection device is embodied as a spectral sensor, that is to say a sensor that is not only capable of ascertaining the emissions of the marker substance at a specific emission maximum, but that is capable of detecting the entire relevant emission spectrum of the mixture, to which in this case preferably an electromagnetic radiation such as light in the UV range, in the visible range or in the IR range is applied.

The detection of the emission spectrum of the mixture permits more accurate conclusions regarding the mixture, and in particular also offers the possibility of detecting multiple marker substances with one sensor, said marker substances for example having been supplied with the aid of various subsidiary conveyors and having different emission maxima.

A modified embodiment according to the invention provides that a multi-screw extruder, for example a double-screw extruder, comprising multiple subsidiary conveyors, is realized.

Further advantages, details and features of the invention emerge from the following description of an exemplary embodiment in conjunction with the drawings.

### BRIEF DESCRIPTION OF THE DRAWING

The only or single FIGURE of the drawing illustrates a schematic view of an embodiment of an extrusion-conveying device according to the invention comprising a single extruder but multiple subsidiary conveyors.

### DESCRIPTION OF SPECIFIC EMBODIMENTS

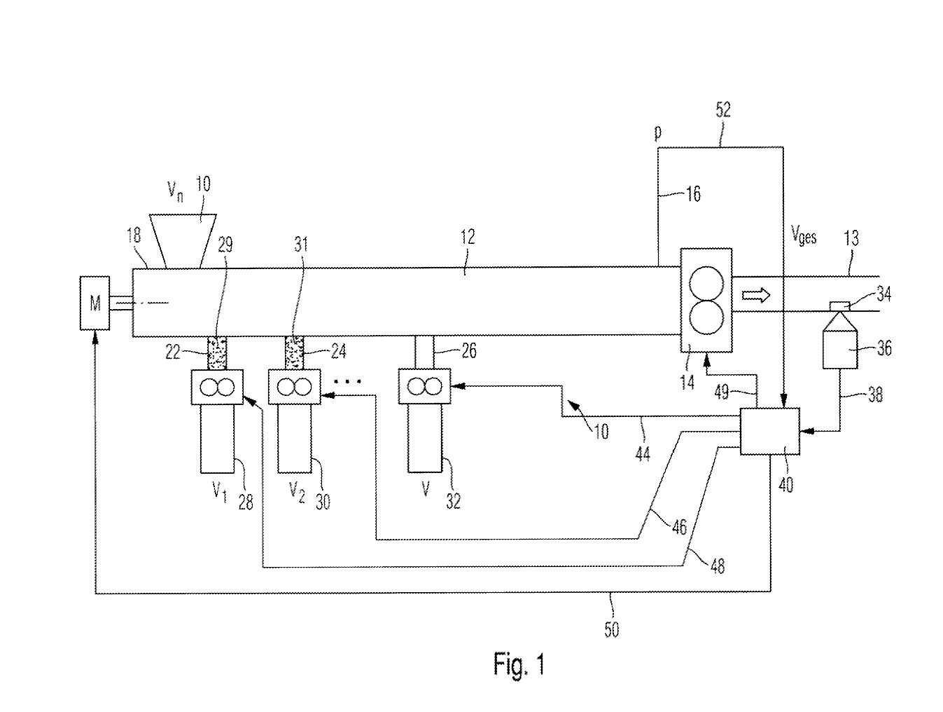

The embodiment of an extrusion-conveying device 10 illustrated in FIG. 1 comprises an extruder 12 forming the central element of the extrusion-conveying device. The extruder is adapted to extrude and convey extrudable mixtures such as rubber mixtures and for example TPE (thermoplastic elastomer). The extruder outputs a volume flow V on its output side which flows in a conduit or pipe 13.

Alternatively it is intended to quickly monitor the extruded material downstream of the output-sided conveyor (14) by directing a sensor of the detection device at this position. In this way, the distribution of the marker substance can be monitored, in fact in two dimensions, and in case of an inequality of the distribution, for example in case of an agglomeration, the intensity of the blending or intermixing can be increased by augmenting the speed of rotation of the extruder for example.

It is also possible to quickly cut open an inventively extruded product or some other inventively treated product by using a knife or a blade. The result are freshly cut surfaces shortly downstream of the respective blade that can also be monitored with the aid of a sensor according to the invention.

It shall be understood that this embodiment is possible in the case that the inventively manufactured product is not a finished product but is further processed as an intermediate product.

A volumetric conveyor 14 or output-sided conveyor that is formed or designed as a gear pump is provided on the output side of the extruder 12 for controlling the mixture output volume. The actuation of the gear pump 14 is independent of the actuation of the extruder 12.

In the illustrated embodiment a pressure sensor 16 is provided shortly before the end of the extruder 12 for measuring the pressure at this position and correspondingly adjusting the drive speed of the extruder.

Various feed locations are provided on the side of the extruder, wherein a subsidiary conveyor 28 is mounted at the first feed location 22. The subsidiary conveyor 28 supplies a component of the mixture, whereas the main component is supplied to the extruder 12 via a feed hopper 11.

In the illustrated embodiment the component that is supplied with the aid of the subsidiary conveyor 28 comprises a marker substance 29.

Correspondingly, a further feed location 24 is provided somewhat downstream of the first feed location, but within the first third part of the extruder. The feed location 24 is coupled to a further subsidiary conveyor 30 and supplies a component with a marker substance 31 to the extruder.

It shall be understood that any number of further subsidiary conveyors may be provided, wherein in the illustrated embodiment a further feed location 26 having a subsidiary conveyor 32 is shown.

In this manner, during the conveyance via the extruder, first the component with the marker substance 29, then the component with the marker substance 31 and any further components, for example also the component from the feed location 26, are supplied to the component Vₙ that is fed via the feed hopper 10. Those components are referred to as V₁, V₂ and V.

The total flow arises out of the sum of the aforementioned component volume flows and is designated as Vₜₒₜₐₗ.

According to the invention, the distribution of the marker substance or the marker substances in the total volume flow of the mixture is inspected downstream of the output-sided conveyor 14. For this reason, a window 34 that is for example provided with pressure-resistant glass, is formed in the conduit or pipe 13, wherein the window is not illustrated here and in particular is formed as a low-reflection window.

Instead of the embodiment having a window as illustrated here, it is also possible to directly insert the sensor via a bore into the pressure-resistant pipe 13 and to have the detection conducted there by having contact with the surface of the flow of the mixture Vₜₒₜₐₗ. The sensor is also capable of analyzing the exposed surface of the mixture in a contactless manner after the pressure-resistant pipe 13.

The sensor 36 is directed towards the mixture Vₜₒₜₐₗ and detects the quality of distribution of the marker substances 29 and 31 in the total volume flow of the mixture. Depending on the detection, the sensor 36 outputs an output signal that is supplied to the inventive control device 40 via an electric connection or line 38. The output signal of the sensor 36 can be an analog signal that merely for example represents the brightness or luminance of the fluorescent marker substances, or a digital signal that for example represents the entire spectral detection spectrum of the sensor 36.

It is possible to measure the number of the detected particles, in fact two-dimensionally, i.e. transverse to the extrusion direction and in the extrusion direction. The particle distance can also be detected and compared to a desired distribution in order to determine whether it is required to increase the speed of rotation of the extruder for enhancing the blending or intermixing of the mixture.

Based on the output signal of the sensor 36 supplied to the control device, the control device determines the mixing ratio between Vᵣ, and for example V₁, or optionally between one or more of the further volume flows of the subsidiary conveyors, wherein it shall be understood that a calibration of the sensor 36 has been carried out in advance in order to calibrate an allocation of the output signal on the connection 38 to the portion of the marker substance 29 or 31, respectively, in the volume flow.

The control device 40 now controls the speed of rotation of the extruder 12 based on the mixing quality and/or the distribution quality given and desired by the user. The mixing ratio between the components according to Vₙ, V₁, V₂ and V does not change as a result of this, but the increase in the speed of rotation via the control line 50 and the motor M of the extruder leads to an improvement of the mixture blending.

If needed, a temperature measurement can be added here as well, in order to avoid overheating of the rubber mixture.

It shall be understood that also the subsidiary conveyors 28, 30 and 32 as well as the extruder or conveyor 14 can be controlled with the aid of corresponding connections 44, 46, 48 and 49 if needed, wherein the mixing ratio shall be kept constant according to the invention.

The output pressure of the pressure sensor 16 as well is inventively supplied to the control device 40 via a line 52.

It shall be understood that a volumetric conveyor can also be provided for supplying the basic component Vₙ if needed; typically, however, this is not required as the supply basically automatically results from the relative speed of rotation ratio of the volumetric conveyor 14 on the one hand, and the volumetric conveyors 28, 30 and 32 on the other hand.

The specification incorporates by reference the disclosure of German priority document 10 2008 051 973.1 filed Oct. 16, 2008.

The present invention is, of course, in no way restricted to the specific disclosure of the specification and drawings, but also is encompasses any modifications within the scope of the appended claims.

What is claimed is:

1. An extrusion conveying device, comprising:
an extruder for mixing components;
a volumetrically operating conveyor disposed at an output side of said extruder;
at least one subsidiary conveyor for supplying to said extruder at least one component having a marker substance;
a detection device for said marker substance disposed on an output side of at least one of said extruder and said volumetrically operating conveyor, wherein said detection device is adapted to detect a distribution quality of said marker substance; and
a control device coupled to said detection device, wherein said control device is adapted to adjust a speed of at least one of said extruder and said volumetrically operating conveyor in response to the distribution quality of said marker substance detected by said detection device.

2. An extrusion conveying device according to claim 1, which includes a further subsidiary conveyor for supplying a further component to said extruder.

3. An extrusion conveying device according to claim 1, which further includes a pressure sensor, which is in particular disposed on an input side of said volumetrically operating conveyor, wherein said pressure sensor is configured to measure an output pressure of the mixture downstream of said extruder, and wherein a speed of at least one of said extruder and said volumetrically operating conveyor is adapted to be regulated by an output signal of said pressure sensor.

4. An extrusion conveying device according to claim 1, wherein a window is provided in the vicinity of an output side of said volumetrically operating conveyor, and wherein said detection device is disposed at said window for detecting at least one of an amount and a distribution of said marker substance in a mixture flowing past said window.

5. An extrusion conveying device according to claim 1, wherein said marker substance is formed by particles that are uniformly distributed in the marker substance/component and that are also uniformly distributed in the mixture by mixing occurring in said extruder.

6. An extrusion conveying device according to claim 1, wherein said detection device is provided with an optical sensor for detecting said marker substance, and wherein said sensor is directed onto a surface of the mixture that flows by and that carries said marker substance.

7. An extrusion conveying device according to claim 1, wherein said detection device is provided with a sensor having a spectral sensitivity that is geared to an emission maximum of said marker substance.

8. An extrusion conveying device according to claim 1, wherein said marker substance is formed by at least one of magnetic or radioactive particles, and fluorescent or luminescent admixtures.

9. An extrusion conveying device according to claim 1, which includes at least two subsidiary conveyors coupled to said extruder, wherein each of said subsidiary conveyors conveys a component having a marker substance, and wherein said marker substances differ from one other.

10. An extrusion conveying device according to claim 1, wherein said control device is adapted to control at least one of a speed of said extruder and an inlet pressure from said extruder into said volumetrically operating conveyor, and wherein said control device (40) is adapted to regulate a desired mixing ratio of the mixture based on an output signal of said detection device.

11. An extrusion conveying device according to claim 10, wherein a speed of said at least one subsidiary conveyor is kept constant.

12. An extrusion conveying device according to claim 10, wherein said control device is also adapted to regulate a speed of at least one of said extruder and said volumetrically operating conveyor.

13. An extrusion conveying device according to claim 1, wherein at least one of said subsidiary conveyors supplies at least one component to said extruder from the side.

14. An extrusion conveying device according to claim 13, wherein said at least one subsidiary conveyor supplies at least one component to an upstream half of said extruder, preferably within the first third of said extruder, and more preferably in particular within a first fifth of the length of said extruder.

15. An extrusion conveying device according to claim 1, wherein said extruder is a double-screw extruder.

16. An extrusion conveying device according to claim 1, wherein one of the components, in particular the component having to said marker substance, is supplied in a regulated manner.

17. An extrusion conveying device according to claim 1, configured for use for extrusion of rubber mixtures or thermoplastic elastomers.

18. An extrusion conveying device according to claim 1, wherein said detection device is provided with a sensor directed directly onto an exposed surface of extruded material coming from said extruder.

19. An extrusion conveying device according to claim 1, wherein said detection device is provided with a cutting device, such as a blade, for dividing extruded material coming from said extruder, and wherein said detection device is further provided with a sensor that downstream of said cutting device is directed directly onto a freshly cut surface of the extruded material.

20. An extrusion conveying device comprising:
an extruder for mixing components;
a volumetrically operating conveyor disposed at an output side of said extruder;
a volumetric subsidiary conveyor for supplying to said extruder at least one component having a marker substance;
a detection device for said marker substance disposed on an output side of at least one of said extruder and said volumetrically operated conveyor, wherein said detection device is adapted to detect a distribution quality of said marker substance; and
a control device coupled to said detection device, wherein said control device is adapted to adjust a speed of at least one of said volumetrically operating conveyor and said subsidiary conveyor in response to the distribution quality of said marker substance detected by said detection device, and wherein a speed ratio between said subsidiary conveyor and said volumetrically operating conveyor is kept constant.
